(19) United States
(12) Patent Application Publication
(10) Pub. No.: US 2007/0277043 A1
(43) Pub. Date: Nov. 29, 2007

(54) Methods for Generating Identification Values for Identifying Electronic Messages

(76) Inventor: Hans Martin Boesgaard Sorensen, Lyngby (DK)

Correspondence Address: HARNESS, DICKEY & PIERCE, P.L.C., P.O. BOX 8910, RESTON, VA, 20195, US

(21) Appl. No.: 10/588,772

(22) PCT Filed: Feb. 10, 2005
(86) PCT No.: PCT/DK05/00090

§ 371 Date: Apr. 5, 2007

Related U.S. Application Data
(60) Provisional application No. 60/542,861, filed on Feb. 10, 2004.
(60) Provisional application No. 60/581,354, filed on Jun. 22, 2004.

(30) Foreign Application Priority Data
Feb. 10, 2004 (DK) PA 2004 00201
Jun. 22, 2004 (DK) PA 2004 00975

(51) Int. Cl. H04L 9/00; G06F 15/16

(52) U.S. Cl. 713/180; 709/206

(57) ABSTRACT

In a method for generating an identification value for identifying an electronic message by application of a first hash function with fixed compression that compresses n blocks of data into a number of blocks, which is smaller than n, the hash function is repetitively applied in a tree-structure compression of the message. The message is compressed in a plurality of tree-structure levels, each level receiving mᵢ input blocks for compression. One or more residual data blocks are treated by an auxiliary hash function or passed without compression from the current level to another subsequent level, in case n does not divide the number of input blocks at a particular level. A further method is provided, in which a number representation of a block of data is added to a number resulting from a hash operation. The methods of the invention may define MAC (Message Authentication Code) functions.

### TECHNICAL FIELD

The present invention generally relates to methods for generating identification values for identifying electronic messages, the methods relying on hash functions. Embodiments of the methods of the invention provide novel hash or MAC (Message Authentication Code) functions. More specifically, the invention provides novel procedures of applying e.g. hash functions to data blocks derived from a message of any given length. In one aspect, the invention relates to a method providing an efficient universal hash function based on a delta-universal hash function.

### BACKGROUND OF THE INVENTION

Hash and MAC functions are useful for ensuring that the contents of an electronic message as received by a recipient is identical to the contents of the same message as sent by a sender. Thus, if a hash or MAC function outputs the same identification value when the function is applied to the sent message as the value generated as an output when the function is applied to the received message, the contents of the message as received is identical to the contents of the message as sent. If, however, the contents of the message have been altered, the hash or MAC function outputs two different identification values.

The term “identification value” may denote a hash value or a cryptographic check-sum which identifies the set of data, cf. for example Applied Cryptography by Bruce Schneier, Second Edition, John Wiley & Sons, 1996. In case a cryptographic key is used as an input for the computations, the hash function is usually referred to as a MAC function (Message Authentication Code).

Various hash and MAC functions have been proposed in the prior art. Procedures for applying such functions to a message, including procedures for breaking the message into blocks for processing by such functions, have also been proposed. FIG. 1 illustrates a prior art method for generating an identification value for identifying an electronic message, including a procedure for breaking a message down into blocks which are processed by hash functions. The method of FIG. 1 is generally disclosed in M. N. Wegman and J. L. Carter: New Hash Functions and their Use in Authentication and Set Equality, J. Computer and System Sciences 22, pp. 265-279 (1981). In this method, an electronic message is divided into a plurality of blocks, for example 5 blocks m_{1,1} . . . m_{1,5}. As the blocks are to be combined in groups, for example as illustrated in FIG. 1 in pairs of two, by application of a hash function, and as 2 does not divide 5, a 6^{th} block is appended to the 5 blocks, the 6^{th} block simply containing the value 0. The 6 blocks are divided into 3 subsets, which are combined by application of the hash function h to obtain 3 resulting numbers (or blocks) m_{2,1} . . . m_{2,3}. As 2 does not divide 3, a 4^{th} block containing the value 0 is appended, and the above procedure of combining is repeated to obtain m_{3,1} and m_{3,2}, which in a final step are combined into output value m_{4,1}.

Accordingly, the hash function h is applied repetitively in a tree-structure compression of the message, such a repetitive application of a hash function being usually also referred to as a “hash function”. The output value of the tree-structure compression may either be used directly as a hash value identifying the original message, or it may be processed further, e.g. by application of a cryptographic function to obtain a MAC value. In FIG. 1, k₁, k₂ etc. denote various cryptographic keys that are applied in the hash function h.

It is apparent from FIG. 1 that the number of hash computations (i.e. the number of applications of the hash function h) in each step is equal to half the number of blocks used as input in respect of each step, and, if 2 does not divide the number of input blocks, the number of hash computations is equal to the number of input blocks plus 1 divided by 2. It has been found that hash functions require significant computational resources, but so far no alternative to appending e.g. a 6^{th} block of data containing the value 0 (as in step 1 of FIG. 1), which could speed up identification value generation, has been proposed.

### SUMMARY OF THE INVENTION

It is an object of preferred embodiments of the invention to provide a method for generating an identification value, which method is capable of processing messages of any length. It is a further object of preferred embodiments of the invention to provide a method which is fast. It is a yet further object of preferred embodiments of the invention to provide a method which is memory efficient in the sense that smaller memory resources are occupied than those required by prior art methods while maintaining a high processing speed.

In a first aspect, the invention thus provides a method for generating an identification value for identifying an electronic message by application of at least one first hash function with fixed compression that compresses n blocks of data into a number of blocks which is smaller than n or into one block, the hash function being repetitively applied in a tree-structure compression of the message, so that the message is being compressed in a plurality of tree-structure levels, each level receiving mᵢ input blocks for compression, subscript i denoting a current level in the tree structure, the method comprising processing an output of the tree-structure compression further to obtain said identification value,

the method being characterized in that

a residual data block is passed without compression from the current level to another, subsequent level in case n does not divide the number of input blocks mᵢ for said current level i.

The step of applying at least one hash function may comprise applying a plurality of different hash functions. The fixed compression may compress the n blocks of data into more than a single block, provided that the compression results in fewer than n blocks. Moreover, the fixed compression may result in one or more blocks which have different length(s) than the lengths of the n blocks used as an input for the compression.

It will be appreciated that method of the first aspect of the present invention mainly differs from the prior art method discussed above with reference to FIG. 1 in that there is no need to append data blocks of zeros in case the number of subsets does not divide the length of the message, and to process such blocks of zeros by a hash function. On the contrary, the present method may be regarded as a method that leaves the residual block(s) unprocessed in one step of compressing by means of the hash function (i.e. in one level of the tree structure) and moves the residual block(s) one step further to a subsequent step of compressing data blocks by means of the hash function (i.e. to a subsequent level of the tree structure). Thus, hash functions are not applied as often as in the prior art method, whereby computational resources may be saved and overall processing speed increased. This will be further discussed in connection with the description of FIG. 2 below.

As mentioned above, the at least one first hash function of the method according to the first aspect of the invention, compresses n blocks of data into a smaller number of blocks, such as into one block. It should be understood that the scope of the appended claims generally extends to any fixed compression compressing a set of data of a given length to obtain a result of a smaller length. For example, eight data blocks of a given length may be compressed into three blocks of the same length by application of the at least one first hash function. This example also falls within the scope of the present claims, as the three blocks resulting from the compression are, in the present context, regarded as one block (which, however, has a length different from the length of each of the three blocks resulting from the compression).

Generally, the method according to the first aspect of the invention provides a method for generating an identification value for identifying an electronic message of any length by application of at least one first hash function with fixed compression that compresses n blocks into a number of blocks which is smaller than n or into one block, the method comprising:
dividing a set of input data derived from the message into a plurality of blocks;
performing a plurality of compression cycles, each i'th cycle comprising:
   inputting mᵢ input blocks to the cycle, mᵢ denoting the number of input blocks to the i'th cycle;
   organizing the mᵢ input blocks into a plurality of subsets, each subset consisting of n blocks;
   if n does not divide mᵢ: defining at most n−1 residual blocks;
   combining the blocks of each subset by means of said at least one first hash function to obtain a resulting number in respect of each subset;
using each resulting number as input data for a next compression cycles, and
using the residual block(s) as a part of said input data for said next cycle or for a further, subsequent cycle,
obtaining, as a result of the plurality of compression cycles, a set of output data which is further processed to obtain said identification value.

In a second aspect, the invention provides a method for generating an identification value for identifying an electronic message by application of at least one first hash function with fixed compression that compresses n blocks of data into a number of blocks which is smaller than n or into one block, the hash function being repetitively applied in a tree-structure compression of the message, so that the message is being compressed in a plurality of tree-structure levels, each level receiving mᵢ input blocks for compression, subscript i denoting a current level in the tree structure, the method comprising processing an output of the tree-structure compression further to obtain said identification value,

the method being characterized in that

it comprises determining whether or not n divides the number of input blocks mᵢ for said current level i; and

if n does divide mᵢ: applying said at least one first hash function mᵢ/n times;

if n does not divide mᵢ:
applying said at least one first hash function at most mᵢ/n times, whereby at least one residual data block is left unprocessed by the first hash function; and
processing said at least one unprocessed data block by means of an auxiliary hash function which, in one single hash operation, compresses the at least one unprocessed data block into one single block.

Preferably, for the purpose of applying the auxiliary hash function, no blocks of zeros or other data are appended.

In case the at least one first hash function is applied less than mᵢ/n times, λ times n data blocks may be left unprocessed in addition to the at least one residual data block, λ denoting an integer, and the step of processing the unprocessed data blocks does in that case preferably comprise processing all of the unprocessed data blocks.

It will be appreciated that the method according to the second aspect of the invention provides an alternative solution to the above objects of the invention. Whereas the method of the first aspect of the invention comprises forwarding a residual data block to a subsequent level in the tree structure without applying a hash function to the residual block, the method according to the second aspect of the invention takes a different approach. More specifically, in a given level of the tree structure, the first hash function is applied fewer times than the truncated value of mᵢ/n, if n does not divide mᵢ, whereby n data blocks and one or more residual data blocks are temporarily left unprocessed. For example, if mᵢ equals 27, and n=2, then the first hash function may be applied 12 times (trunc(27/2) equals 13, and accordingly the first hash function is, in accordance with the second aspect of the invention, applied at most 12 times). This leaves n=2 data blocks and 1 “residual data block”, i.e. a total of 3 data blocks, unprocessed. Finally, these 3 unprocessed data blocks are processed by the second hash function which performs 3:1 compression.

Also the method according to the second aspect of the invention mainly differs from the prior art method discussed above with reference to FIG. 1 in that there is no need to append data blocks of zeros in case the number of subsets does not divide the length of the message, and to process such blocks of zeros by a hash function. The present method does instead apply the second hash function which compresses more than n blocks into a single block, so as to thereby take into account that n does not divide mᵢ. Again, the possibility is conferred not to apply hash functions as often as in the prior art method, whereby computational resources may be saved and overall processing speed increased. This will be further discussed in connection with the description of FIG. 7 below.

The step of applying the at least one first hash function less than mᵢ/n times may include not applying the first hash function at all. For example, if 3 data blocks are to be processed, and the first hash function would normally perform 2:1 compression, it would make no sense to apply the first hash function to 2 of the 3 blocks to be processed. In this case, 2 data blocks and one residual data block are left unprocessed by the first hash function, and these three data blocks are then processed by the auxiliary hash function.

In a third aspect, the invention provides a method for generating an identification value for identifying an electronic message, the method comprising the steps of:
processing at least one block of a set of data (M₁, . . . ,Mₘ) derived from the message into a resulting number h by means of a hash function which is at least delta-universal, h=f(M₁, . . . , Mₘ); and
adding a number representation (Mₘ₊₁) of a further block of data derived from the message to the resulting number to obtain a modified resulting number, h′=h+Mₘ₊₁;
using the modified resulting number h′ further to obtain said identification value.

Also the method according to the third aspect of the invention differs mainly from the prior art method discussed above with reference to FIG. 1 in that there is no need to process all the data blocks derived from the message by a hash function. The present method may be regarded as a method that only applies a hash function to some of the blocks derived from the message, and which performs an addition of non-hashed data blocks to hashed data blocks. In later repetitions of the steps of processing and adding, data blocks which have previously been hashed may become data blocks which are not hashed in such later steps, but which instead are added to other data blocks hashed in such later steps. As a result of adding data blocks rather than applying hash functions to all the data blocks, Hash functions are not applied as often as in the prior art method, whereby computational resources may be saved and overall processing speed increased. This will be further discussed in connection with the description of FIGS. 8-10 below.

In the method according to the third aspect of the invention, the modified resulting number may be determined by the function:
(m₁+k mod2³²)·(LSR(m₁,32)+LSR(k,32) mod2³²)+m₂ mod2⁶⁴,
where m₁ and m₂ denote two of said blocks of data, LSR(x,y) denotes a logical-shift-right by y bits of input x, and k denotes a cryptographic key, whereby m₁, m₂ and k are represented as 64 bit unsigned integers. In respect of the above function, the term (m₁+k mod 2³²)·(LSR(m₁,32)+LSR(k,32) mod2³²) constitutes a so-called LNH function known per se, which is delta-universal with regard to the addition operator mod 2⁶⁴. The addition of m₂ results in the function being universal, however thanks to the addition of m₂, the function may accept additional input in the form of one more block.

In summary, it will be understood that, in all aspects of the invention, hash functions are not applied as often as in the prior art method. As hash functions include non-linear computations, such as multiplications, which require more computational resources than linear computations, such as additions, substantial computational resources can be saved by reducing the number of applications of hash functions. In preferred embodiments of the invention, the ultimately generated identification value is a function of all input bits, i.e. of all bits of the message, so that it is ensured that the security of the methods is not compromised.

In the present context, the term “function which is at least delta-universal” should be understood to designate a function which is at least delta-universal with regard to a given addition operator, such as bitwise XOR, addition mod 2ⁱ, where i is an integer, or addition over the integers.

Also, in the present context, the term message should be understood as any set of digital data, such as e-mail, electronic files of any kind, including digital images, executable files, text files, digital sound, video, etc.

As mentioned above, the term “identification value” may be a hash value or a cryptographic check-sum which identifies the set of data, cf. for example Applied Cryptography by Bruce Schneier, Second Edition, John Wiley & Sons, 1996. In case a cryptographic key is used as an input for the computations, the hash function is usually referred to as a MAC function (Message Authentication Code).

In a broad definition, a cryptographic key may be regarded as an input value for an algorithm of a cryptographic system, the key being used for initializing iterations.

Herein, the term universal hash function is to be understood as a member of a universal hash function family as defined by Carter and Wegman: Universal Classes of Hash Functions, J. Computer and System Sciences 18, pp. 143-154 (1979), or as a member of a “ε-almost-universal” hash function family by the definition of Stinson: Universal Hashing and Authentication Codes, “Advances in Cryptology—CRYPTO '91”, Lecture Notes in Computer Science 576, pp. 74-85 (1992). The term delta-universal is to be understood as a member of a “Δ-universal” or “ε-almost-Δ-universal” hash function family by the definition of Stinson: On the connections between universal hashing, combinatorial designs and error-correcting codes, Congressus Numerantium 114, pp. 7-27 (1996).

It will be understood that the methods of the first, second and third aspects of the invention may be combined in one single application. For example, the method of one of the aspects may be applied in respect of selected blocks or in selected levels in the tree structure, whereas the method of one or two of the other aspect(s) may be applied in respect of other blocks or levels.

The invention also provides computer systems which are programmed to perform the methods of the invention as well as computer program products comprising means for performing the methods of the invention.

### BRIEF DESCRIPTION OF THE DRAWINGS

FIG. 1 illustrates a prior art method as discussed above;

FIGS. 2 and 3 illustrate an embodiment of the method according to the first aspect of the invention;

FIG. 4 illustrates the initial processing of an incoming message M in a method according to any of the aspects of the invention;

FIGS. 5 and 6 illustrate final processing steps of one embodiment of any of the methods according to the invention;

FIG. 7 illustrates an embodiment of the method according to the second aspect of the invention;

FIGS. 8-10 illustrate an embodiment of the method according to the third aspect of the invention.

### DETAILED DESCRIPTION OF THE INVENTION

In FIG. 2, an electronic message of a given length is divided into four blocks m_{1,1} . . . m_{1,4} and into 2 subsets of two blocks each. The subsets are thus defined by m_{1,1}, and m_{1,2}; m_{1,3} and m_{1,4}. The remaining block m_{1,5} is hereinafter referred to as residual block m_{1,5}. The first part of the indices 1,1; 1,2 etc. denotes a current level in the tree structure, i.e. level 1 in the upper row in FIG. 2, and the second part of the indices represents a block identifier, i.e. block 1, 2 . . . 5. The blocks of each subset are combined by means of hash functions h₁, which use a first cryptographic key k₁. The step of compressing the blocks of each subset results in two resulting numbers m_{2,1}, and m_{2,2}, which subsequently are compressed by means of a hash function into a further resulting number m_{3,1}, the hash function using a second cryptographic key k₂. Finally, the residual block m_{1,5} and resulting number m_{3,1} are compressed by means of a hash function into resulting number m_{4,1}, which also constitutes an output.

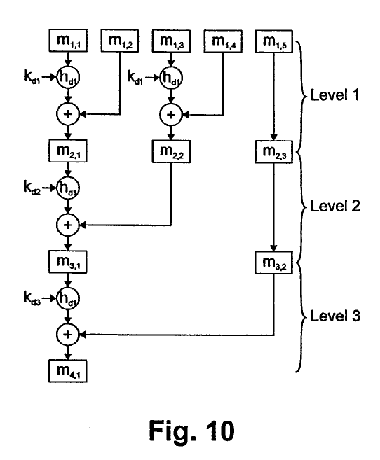

In accordance with the third aspect of the invention and as described in detail below with reference to FIG. 10, the hash function hi of FIG. 2 may comprise a delta-universal hash function h_{d1} which is applied to one data block at a time only, and to which a second data block is added following the processing by the hash function. For example, in FIG. 2, hash function h₁ may be substituted by hash function h_{d1} which uses m_{1,1} as an input and applies cryptographic key k₁ or an alternative cryptographic key k_{d1}. Data block m_{1,2} may then be added to the output of hash function h_{d1}.

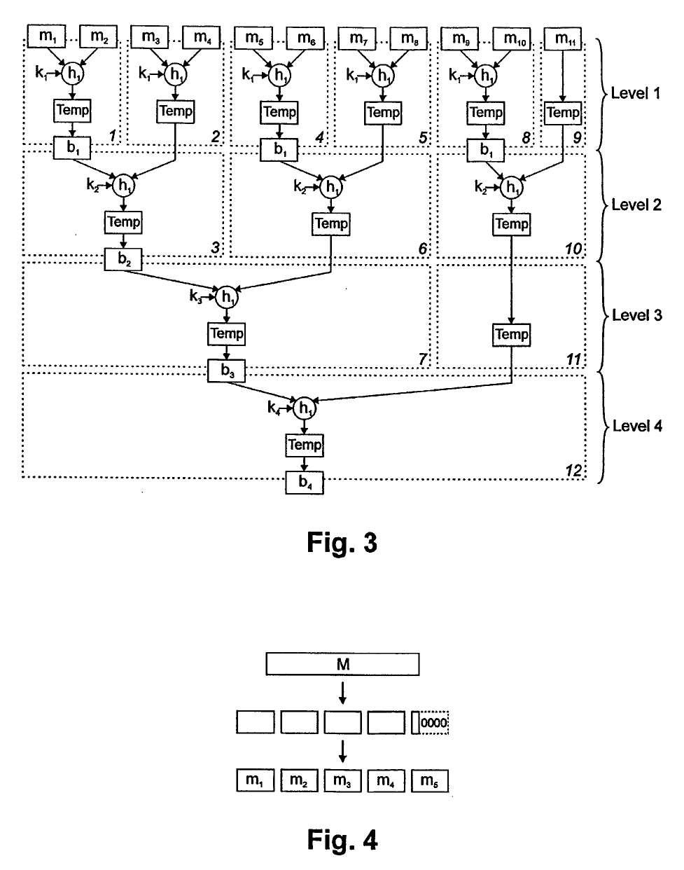

FIG. 3 illustrates a practical application of the method according to the first aspect of the invention applied to a message which is divided into 11 blocks m₁ . . . m₁₁. The application of FIG. 3 utilizes a minimum of memory capacity, as will be described further below. The numbered dashed boxes in FIG. 3 indicate the order in which the individual operations of the method are performed. Thus, the operations shown in dashed box 1 in the upper left corner of FIG. 3 are performed first. More specifically, as a new message is processed, two initial data blocks m₁ and m₂ are compressed by means of a first hash function h, which in the example shown in FIG. 3 is a key-dependent hash function, e.g. a universal hash function, that makes use of cryptographic key k₁. The result of the compression is temporarily stored in a temporary register (or in a temporary variable) denoted “Temp”, from which it is immediately passed on to a buffer variable b₁ of level 1 of the tree structure. Next, the operations of box 2 are performed, whereby data block m₃ and m₄ are compressed by the same hash function and the same cryptographic key k₁ as applied in respect of m₁ and m₂. In alternative embodiments of the invention, the hash function of box 2 may be different from the hash function of box 1, cf. the general discussion of different hash functions set forth below in connection with the description of FIGS. 2 and 3. The result of the compression of m₃ and m₄ is temporarily stored in the “Temp” register (or variable), this register being available now, as its previous contents has been moved to buffer variable b₁, cf. box 1.

In box 3, buffer variable b₁ and the “Temp” variable are compressed by means of hash function h which utilizes cryptographic key k₂, i.e. a cryptographic key which is different from the cryptographic key k₁ used in the first level. The result of this compression is temporarily stored in the now available “Temp” register and passed on to a buffer variable b₂ of level 2. In boxes 4 and 5, the procedures described above in connection with boxes 1 and 2 are repeated, so as to compress input blocks m₅ . . . m₈. As the contents of buffer variable b₁ have been utilized in box 3, this buffer variable is available in box 4 for the result of the compression of m₅ and m₆. In box 6, the contents of buffer variable b₁ and the “Temp” register are compressed, the result being temporarily stored in the “Temp” register and immediately thereafter compressed together with the contents of buffer variable b₂, cf. box 7, the result being passed on to the buffer of level 3, b₃, via the “Temp” register. Next, as illustrated in box 8, input blocks m₉ and m₁₀ are compressed, the result of the compression being store in the “Temp” register and passed on to the b₁ buffer variable. As the hash function h performs 2:1 compression, and as no twelfth block is available for compression with m₁₁, block m₁₁ is simply passed on to the second level of the tree structure by being temporarily stored in the “Temp” register, in accordance with the first aspect of the invention. In box 10, the contents of b₁ and the contents of the “Temp” register (i.e. m₁₁) are compressed, and the result is temporarily stored in the “Temp” register. In respect of the compression to be performed in level 3, no fourth block is available which could be compressed together with the current contents of the “Temp” register, and thus, as illustrated by box 11, the contents of the “Temp” register are passed on to level 4. Finally, in level 4, the contents of the buffer of level 3, b₃, and the “Temp” register are compressed to produce an output, denoted in box 12 as a buffer variable of level 4, b₄.

From the above discussion of FIG. 3, it will be appreciated that the result of each hash function is temporarily stored in the “Temp” register and, if the buffer variable bᵢ of the level concerned (i.e. level i) is available, passed directly on to this buffer variable. If the buffer variable bᵢ is not available, then the contents of the “Temp” register are immediately compressed in the next level i+1 together with the contents of the buffer variable bᵢ by means of a hash function. This procedure is carried out in respect of each application of hash function h (i.e. horizontally in FIG. 3) and in respect of each level of the tree structure (i.e. vertically in FIG. 3) in the order described above, i.e. in the order revealed by the numbering of the dashed boxes of FIG. 3.

The memory requirements for performing the procedure of FIG. 3 are minimized, as only one buffer variable bᵢ per level and one single temporary variable are required in order to perform the tree-structure compression of the message.

In accordance with the third aspect of the invention the hash function h₁ of FIG. 3 may comprise a delta-universal hash function h_{d1} which is applied to one data block at a time only, and to which a second data block is added following the processing by the hash function as generally described below in connection with FIG. 10.

In FIGS. 2 and 3, different cryptographic keys k may be applied in each application of the hash function h. In other words, each time the hash function h is applied, a new cryptographic key may be used. Accordingly, in for example level 1 of FIGS. 2 and 3, the keys denoted k₁ may not be the same, whereby k₁ varies horizontally in the tree structure. In presently preferred embodiments, one single cryptographic key is, however, used in all applications of the hash function h in one single level of the tree structure. In such preferred embodiments, different keys k₁, k₂, . . . are applied in different levels of the tree structure, so that one single key is used in all applications of the hash function h within a single level.

The cryptographic keys k₁, k₂, . . . may be generated by any appropriate key generation method, such as in a stream- or block-cipher system. In one embodiment, the keys may be generated as outputs of a pseudo-random number generator which receives a seed key as input. In principle, any sufficiently secure pseudo-random number generator may be applied, e.g. the one disclosed in WO 03/104969, which is hereby incorporated by reference.

It will be understood that any message of any given length may be processed according to the principle described above in connection with FIGS. 2 and 3. In FIGS. 2 and 3, the number of bits in the message to be processed is a multiple of the length of each block. However, this is not always the case, and in order to process all message lengths, including those which are not a multiple of the block length, the present method may comprise the step of appending a set of predefined data to the message, so that the length of the message with the appended set of data becomes a multiple of the length of the blocks, as illustrated in FIG. 4. The incoming message M is divided into a plurality of blocks, each having a predetermined block length, and a remainder data block of a size smaller than block length. In the example shown in FIG. 4, a series of zeros are appended to the remainder data block, whereby the remainder data block with appended zeros defines a block of the desired predetermined block length, so that the message eventually is split into five blocks m₁ . . . m₅. The message may now be processed, e.g. as described above in connection with FIGS. 2 or 3. If, in the example of FIG. 3, it is determined that there are not sufficient bits available in the incoming message to define a full block m₁₁, the step of appending data to the message would preferably occur at the time of storing m₁₁ (i.e. the remainder data block of the incoming message with appended data) in the “Temp” register, cf. dashed box 9 in FIG. 3.

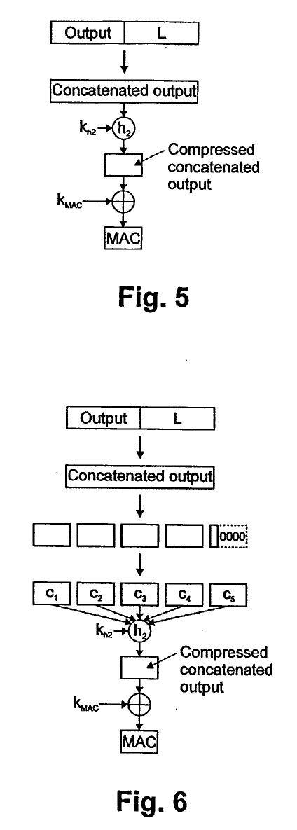

The output of the tree-structure processing illustrated in FIGS. 2 and 3, i.e. for example m_{4,1} of FIG. 2 and b₄ of FIG. 3, is further processed before the identification value is generated. In order to take the length of the message into account and thereby to ensure that two different messages of different lengths result in different identification values, a concatenated output may be generated by appending data which represent the length of the incoming message, as illustrated in FIG. 5. The data representing L may for example represent the total number of bits, bytes or data blocks of the incoming message. This concatenated output may subsequently be compressed by application of a second hash function h₂ which may optionally make use of a cryptographic key kₕ₂, to produce a compressed concatenated output. The data representing the length of the message should uniquely identify the length. Accordingly, in a setup, in which all message lengths are determined as a number of bytes, then also the length of the incoming message which is appended to obtain the concatenated output may be determined as a number of bytes. Otherwise, the data representing the length will typically represent the number of bits of the message. The length L of the message may be known to the system in which the method is applied before processing in the tree structure is initiated, or it may be determined along with such processing. For example, as the incoming message is split into blocks m_{1,1} . . . m_{1,5}, cf. FIG. 2, or m₁ . . . m₁₁, cf. FIG. 3 (in which the message is split into blocks successively as the blocks are being processed in the tree-structure), the number of bits in the message may be simultaneously counted to obtain a measure of the length of the message.

The second hash function h₂ may be the same function as the first hash function applied in the tree structure, or it may be a different hash function. It may be advantageous with respect to security (i.e. to minimize the probability that the same identification value may be generated in respect of two different messages) to apply a strongly-universal hash function as h₂. The term strongly-universal is to be understood as a member of a “strongly-universal” or “ε-almost-strongly-universal” hash function family by the definition of Stinson: Universal Hashing and Authentication Codes, “Advances in Cryptology—CRYPTO '91”, Lecture Notes in Computer Science 576, pp. 74-85 (1992).

In FIG. 5, a cryptographic function is applied to the compressed concatenated output. More specifically, a cryptographic key k_{MAC} is bitwise XOR'ed with the compressed output to obtain a MAC value as the final identification value identifying the message. As an alternative to the XOR operator, any symmetric or asymmetric encryption method can be applied, such as AES or RSA. The cryptographic key k_{MAC} may be generated by any appropriate key generation method. It may thus, for example, define a symmetric or asymmetric key generated by a stream- or block-cipher system. A sender and a recipient of the message should posses identical keys k_{MAC} in order for them to be able to generate identical identification values in respect of the same message. In one embodiment, the key may be generated as an output of a pseudo-random number generator which receives a seed key as input. In principle, any sufficiently secure pseudo-random number generator may be applied, e.g. the one disclosed in WO 03/104969.

It will be understood that embodiments of the method of the invention are envisaged, in which no cryptographic key k_{MAC} is applied to obtain a MAC value. In such embodiments, the identification value may for example be derived as the compressed concatenated output, or simply as the output of the tree-structure compression (m_{4,1} in the example of FIG. 2 or b₄ in the example of FIG. 3). In such cases, the identification value would be referred to as a hash value, and the overall method would also be referred to as a hash function, despite the fact that also the individual functions h are also referred to as hash functions.

An example of a typical application of a hash function (i.e. identification value generation not involving encryption by XOR'ing with a cryptographic key k_{MAC}) is the identification of a password used for user log-on to e.g. a server. Instead of transmitting the user's password via a network, the hash value, i.e. identification value derived from the password, may be transmitted. A MAC function is typically applied for identifying a message, e.g. an e-mail message, sent from a sender to a recipient, both of which posses an appropriate cryptographic key.

FIG. 6 shows one specific way of performing the procedure of FIG. 5. In FIG. 6, the concatenated output is divided into separate data blocks of a given length. If the length of the concatenated output is not a multiple of the given length, a set of predetermined data, e.g. a series of zeros, is appended or otherwise inserted at a predetermined position, to define an integer number of blocks, e.g. c₁ . . . c₅ in the example of FIG. 6. The blocks c₁ . . . c₅ are compressed by means of the second hash function h₂ which optionally makes use of a cryptographic key kₕ₂.

To improve the quality of the identification value generated by the method according to the invention, i.e. to reduce the probability of the method generating identical values in respect of different messages, a further hash function (not shown in the figures) may be applied to the output, a further set of data derived from the output, the concatenated output, and/or the compressed concatenated output. The further hash function is particularly relevant in case the second hash function h₂ is identical to the first hash function h₁. The first hash function h₁ may be a function different from the second hash function h₂.

While, in the examples of FIGS. 2 and 3, h₁ is shown as one specific function which is applied a plurality of times in the tree-structure compression, different functions may be applied. For example, two different of the h₁ hash functions may compress different numbers of blocks. The h₁ function or functions may compress a variable number of blocks. In one embodiment, 2:1 compression is performed in one or more levels of the tree structure, and in other levels 3:1 compression is performed.

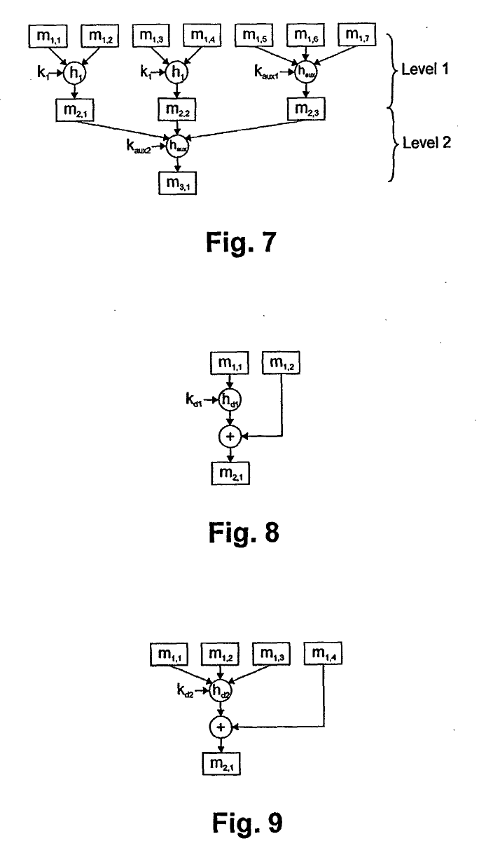

Alternatively, in accordance with the second aspect of the invention, various compression rates may be applied in one single level of the tree structure. This is illustrated in FIG. 7, in which 2:1 compression is performed by a first hash function h₁ on m_{1,1} . . . m_{1,4}, and 3:1 compression is performed by an auxiliary hash function hₐᵤₓ on m_{1,5} . . . m_{1,7} in the first level. In the second level, only 3:1 compression is performed. The first hash function h₁ uses a first cryptographic key k₁, and in level 1, the auxiliary hash function uses a first auxiliary cryptographic key kₐᵤₓ₁, and in level 2, the auxiliary hash function uses a second auxiliary key kₐᵤₓ₂.

It should be understood that the above description of FIGS. 3-6 and the features discussed in relation thereto apply equally to the second aspect of the invention.

FIGS. 8-10 illustrate the method of the third aspect of the invention. The method is generally illustrated in FIG. 8, wherein data block m_{1,1} derived from a message is processed by a delta-universal hash function h_{d1} (i.e. delta-universal with respect to the type of addition applied), which applies a first cryptographic key k_{d1}. Data block m_{1,2} is then added to the number resulting from the delta-universal hash function to obtain a modified resulting number m_{2,1} which can be used to obtain an identification value for identifying the message. For example, the modified resulting number m_{2,1} may be applied as illustrated in FIGS. 5 or 6 by using the modified resulting number as “Output”, to which a representation of the length L of the message is appended to obtain the concatenated output, which in turn is used to obtain the compressed concatenated output, from which the MAC value is derived, as described in connection with FIGS. 5 and 6.

FIG. 9 illustrates a similar embodiment of the method according to the third aspect of the invention, in which the incoming message is divided into four blocks m_{1,1} . . . m_{1,4}, three of which are compressed by application of an alternative delta-universal hash function h_{d2}, which applies one or more cryptographic keys k_{d2}. The fourth block is added to the number resulting from the hash function h_{d2} to obtain a modified resulting number m_{2,1} which may be processed to obtain an identification value as described above in connection with FIG. 8 and FIGS. 5 and 6.

FIG. 10 illustrates yet another embodiment of the method of the third aspect of the invention. In this embodiment, the method is applied in a tree structure of the type described above in connection with FIGS. 2 and 3, in which the message is compressed in a plurality of tree-structure levels. In a first level of the tree structure, incoming data block m_{1,1} is processed by a first delta-universal hash function h_{d1}, and incoming data block m_{1,2} is added to the resulting number of h_{d1} to obtain m_{2,1}, which, in a second level of the tree structure, is processed by hash function h_{d1}. Incoming blocks m_{1,3} and m_{1,4} are processed likewise in the first level to obtain m_{2,2}, and in the second level m_{2,2} is added to the number resulting from hash function h_{d1} applied to m_{2,1}, and m_{3,1} is obtained. Incoming data block m_{1,5} is passed from the first to the third level without processing thereof, as depicted in FIG. 10, in which the data block is referred to as m_{2,3} in the second level and as m_{3,2} in the third level for the sake of clarity. In the third level in the tree structure, the hash function h_{d1} is applied to m_{3,1}, and m_{3,2} (i.e. m_{1,5}) is added to the resulting number to obtain m_{4,1}, from which the identification value can be derived as described above in connection with FIG. 8 and FIGS. 5 and 6.

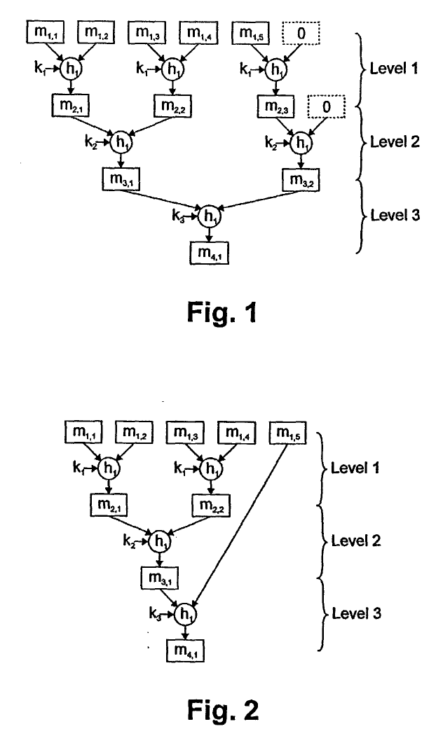

It will be understood that the delta-universal hash function defined in connection with the third aspect of the invention, embodiments of which are described with reference to FIGS. 8-10, may be applied in the first and second aspect of the invention. For example, the so-called first hash function h₁ of the method according to the first and second aspect of the invention may comprise the delta-universal hash function h_{d1} and the subsequent step of adding a data block to the number resulting from the delta-universal hash function h_{d1}. In other words, in one embodiment, the method of FIG. 2 is identical to the method of FIG. 10. Likewise, in dashed box No. 1 of FIG. 1, hash function h₁ may comprise the application of a delta-universal hash function h_{d1} to incoming data block m₁ and subsequent addition of incoming data block m₂ to the number resulting from the delta-universal hash function to obtain the result of the compression to be store in the temporary register “Temp”.

1. A method for generating an identification value for identifying an electronic message by application of at least one first hash function with fixed compression that compresses n blocks of data into a number of blocks which is smaller than n or into one single block, the hash function being repetitively applied in a tree-structure compression of the message, so that the message is being compressed in a plurality of tree-structure levels, each level receiving mᵢ input blocks for compression, subscript i denoting a current level in the tree structure, the method comprising processing an output of the tree-structure compression further to obtain said identification value,
characterized in that
a residual data block is passed without compression from the current level to another, subsequent level in case n does not divide the number of input blocks mᵢ for said current level i.

2. A method according to claim 1, further comprising the step of inserting a set of predefined data at a predetermined position in the message, e.g. by appending the set of predefined data to the message, so that the length of the message with the appended set of data becomes a multiple of the length of the blocks.

3. A method according to claim 1 or 2, wherein the tree-structure compression is performed until the number of blocks is less than n.

4. A method according to claim 3, further comprising the step of concatenating the output with data which represent a length L of the message to obtain a concatenated output, the length L representing the length of the message without said appended set of data.

5. A method according to claim 4, wherein a hash function is applied to the concatenated output to obtain a compressed concatenated output, said hash function being one of:
the at least one first hash function; and
a second hash function.

6. A method according to any of the preceding claims, further comprising applying a further hash function to at least one of:
said output,
a further set of data derived from said output,
said concatenated output, and
said compressed concatenated output.

7. A method according to any of the preceding claims, further comprising applying a cryptographic function to said output or to a further set of data derived from said output.

8. A method according to claim 6 or 7, wherein at least one of:
said at least one first hash function;
said second hash function; and
said further hash function
makes use of at least one cryptographic key.

9. A method according to claim 8, wherein different cryptographic keys for the at least one first hash function are used in different levels of the tree structure.

10. A method according to claim 8 or 9, wherein different cryptographic keys are used in one level of the tree structure.

11. A method according to claim 8 or 9, wherein the same cryptographic key is used in a single level of the tree structure.

12. A method according to any of the preceding claims, wherein at least one of:
said first hash function;
said second hash function; and
said further hash function
is a universal hash function.

13. A method according to any of the preceding claims, wherein at least one of:
said at least one first hash function;
said second hash function; and
said further hash function
comprises at least two different hash functions.

14. A method according to claim 13, wherein the at least two different hash functions compress different numbers n of blocks.

15. A method according to claim 13 or 14, wherein at least one of the at least two different hash functions compresses a variable number n of blocks.

16. A method according to any of claims 13-15, wherein the different hash functions use different cryptographic keys.

17. A method according to any of claims 8-16, comprising performing a plurality of tree-structure compressions of the message to obtain a plurality of results, and concatenating the plurality of results into a concatenated result.

18. A method according to claim 17, wherein different cryptographic keys are applied in the plurality of tree-structure compressions.

19. A method according to claim 17, wherein partly identical cryptographic keys are applied in the plurality of tree-structure compressions.

20. A computer system comprising a memory and a processor, the processor being programmed to carry out the method of any of claims 1-19.

21. A computer program product comprising means for performing the method of any of claims 1-19.

22. A method for generating an identification value for identifying an electronic message by application of at least one first hash function with fixed compression that compresses n blocks of data into a number of blocks which is smaller than n or into one single block, the hash function being repetitively applied in a tree-structure compression of the message, so that the message is being compressed in a plurality of tree-structure levels, each level receiving mᵢ input blocks for compression, subscript i denoting a current level in the tree structure, the method comprising processing an output of the tree-structure compression further to obtain said identification value,
characterized in that
the method comprises determining whether or not n divides the number of input blocks mᵢ for said current level i; and
if n does divide mᵢ: applying said at least one first hash function mᵢ/n times;
if n does not divide mᵢ:
applying said at least one first hash function at most mᵢ/n times, whereby at least one residual data block is left unprocessed by the first hash function; and
processing said at least one unprocessed data block by means of an auxiliary hash function which, in one single hash operation, compresses the at least one unprocessed data block into one single block.

23. A method according to claim 22, further comprising the step of inserting a set of predefined data at a predetermined position in the message, e.g. by appending the set of predefined data to the message, so that the length of the message with the appended set of data becomes a multiple of the length of the blocks.

24. A method according to claim 22 or 23, wherein the tree-structure compression is performed until the number of blocks is less than n.

25. A method according to claim 24, further comprising the step of concatenating the output with data which represent a length L of the message to obtain a concatenated output, the length L representing the length of the message without said appended set of data.

26. A method according to claim 25, wherein a hash function is applied to the concatenated output to obtain a compressed concatenated output, said hash function being one of:
the at least one first hash function; and
a second hash function.

27. A method according to any of claims 22-26, further comprising applying a further hash function to at least one of:
said output,
a further set of data derived from said output,
said concatenated output, and
said compressed concatenated output.

28. A method according to any of claims 22-27, further comprising applying a cryptographic function to said output or to a further set of data derived from said output.

29. A method according to any of claims 22-28, wherein at least one of:
said at least one first hash function;
said second hash function; and
said further hash function
makes use of at least one cryptographic key.

30. A method according to claim 29, wherein different cryptographic keys for the at least one first hash function are used in different levels of the tree structure.

31. A method according to claim 29 or 30, wherein different cryptographic keys are used in one level of the tree structure.

32. A method according to claim 29 or 30, wherein the same cryptographic key is used in a single level of the tree structure.

33. A method according to any of claims 22-32, wherein at least one of:
said first hash function;
said second hash function; and
said further hash function
is a universal hash function.

34. A method according to any of claims 22-33, wherein at least one of:
said at least one first hash function;
said second hash function; and
said further hash function
comprises at least two different hash functions.

35. A method according to claim 34, wherein the at least two different hash functions compress different numbers n of blocks.

36. A method according to claim 34 or 35, wherein at least one of the at least two different hash functions compresses a variable number n of blocks.

37. A method according to any of claims 34-36, wherein the different hash functions use different cryptographic keys.

38. A method according to any of claims 29-37, comprising performing a plurality of tree-structure compressions of the message to obtain a plurality of results, and concatenating the plurality of results into a concatenated result.

39. A method according to claim 38, wherein different cryptographic keys are applied in the plurality of tree-structure compressions.

40. A method according to claim 38, wherein partly identical cryptographic keys are applied in the plurality of tree-structure compressions.

41. A computer system comprising a memory and a processor, the processor being programmed to carry out the method of any of claims 22-40.

42. A computer program product comprising means for performing the method of any of claims 22-40.

43. A method for generating an identification value for identifying an electronic message, the method comprising the steps of:
processing at least one block of a set of data derived from the message into a resulting number by means of a hash function which is at least delta-universal; and
adding a number representation of a further block of data derived from the message to the resulting number to obtain a modified resulting number;
using the modified resulting number further to obtain said identification value.

44. A method according to claim 43, wherein the hash function operates on a single block of data only.

45. A method according to claim 43 or 44, wherein the delta-universal hash function is repetitively applied in a tree-structure compression of the message, so that the message is being compressed in a plurality of tree-structure levels, each tree-structure receiving mᵢ input blocks for compression, the delta-universal hash function and the subsequent step of adding performing a compression of n data blocks into one single data block.

46. A method according to claim 45, wherein a residual data block is passed without processing thereof from a current level to another subsequent level in case n does not divide the number of input blocks mᵢ for said current level i.

47. A method according to any of claims 43-46, wherein the modified resulting number is determined by the function:
(m₁+k mod2³²)·(LSR(m₁,32)+LSR(k,32) mod 2³²)+m₂ mod 2⁶⁴,
where m₁ and m₂ denote two of said blocks of data, LSR(x,y) denotes a logical-shift-right by y bits of input x, and k denotes a cryptographic key, whereby m₁, m₂ and k are represented as 64 bit unsigned integers.

48. A computer system comprising a memory and a processor, the processor being programmed to carry out the method of any of claims 43-47.

49. A computer program product comprising means for performing the method of any of claims 43-47.
